(19) United States
(12) Patent Application Publication
(10) Pub. No.: US 2007/0110964 A1
(43) Pub. Date: May 17, 2007

(54) Object provided with protected information and method

(76) Inventors: Horst-Michael Beier, Augsburg (DE); Lothar Kolber, Munchen (DE); Georgios Kabitoglou, Taufkirchen (DE); Gabriel Rodriguez, Cardedeu (ES)

Correspondence Address: BACON & THOMAS, PLLC, 625 SLATERS LANE, FOURTH FLOOR, ALEXANDRIA, VA, 22314, US

(21) Appl. No.: 10/531,465

(22) PCT Filed: Nov. 11, 2003
(86) PCT No.: PCT/EP03/12591

§ 371 Date: Jan. 8, 2007

(30) Foreign Application Priority Data
Nov. 12, 2002 (DE) 102 52 521.8

(51) Int. Cl. B41M 5/00

(52) U.S. Cl. 428/195.1

(57) ABSTRACT

The invention relates to an object (20) with information (16) to be secured provided thereon, such as a coding, identification, PIN number or the like, and a security cover sticker (18) for covering the information (16) to be secured. The object (20) and the information (16) to be secured have disposed therebetween an additional layer (30) whose adhesive power to the cover sticker (18) is greater at least in partial areas than the adhesive power of the additional layer (30) to the object (20).

This invention relates to an object with information to be secured provided thereon, such as a coding, identification, PIN number or the like, and a security cover sticker for covering the information to be secured. The invention relates further to a method for producing such an object as well as a method for securely marking an object.

It is known to use security cover stickers for covering secret numbers, PIN numbers or other identifications on value documents such as bank or credit cards, prepaid phonecards and the like. The cover stickers are frequently formed as opaque scratch labels which can be removed by scratching and thereby reveal the information located thereunder. Since the information often represents considerable value, numerous measures have been proposed for impeding or preventing abuse by unauthorized users or at least making an attempt at tampering recognizable once it is. made. Otherwise the value of a prepaid phonecard associated with the identification number, for example, could be spent by an unauthorized user and the card then resold as a card whose worthlessness is not recognizable.

The print DE 199 62 638 A1 describes a film element with a self-adhesive layer as a security cover for codings, identifications or the like, said film element consisting of a shrink film material, namely a cold-drawn thermoplastic film. When an attempt is made to detach the film element by the action of heat, it shrinks irreversibly, thereby making the attempt at tampering apparent.

The print GB 2 355 431 A proposes securing prepaid phonecards by covering the access code with a scratch label which has a transparent base layer and a plurality of easily scratched off, opaque cover layers provided on the base layer. The base layer is provided with a number of security slits which prevent the base layer from being detached in one piece with the cover layers. Instead, the base layer is to tear along the security slits upon an attempt to take off the scratch label, so that the label falls apart, thereby making the attempt at tampering recognizable.

A disadvantage of known proposed solutions is that conventional security labels are still relatively easy to pull off or can be removed undamaged from the object to be secured with a scalpel for example. Unauthorized reading of the protected identifications can result in considerable economic damage. Furthermore, successful attempts at fraud reduce the acceptance and confidence of users.

The invention is therefore based on the problem of providing an object with information to be secured of the type stated at the outset which has increased security from tampering.

This problem is solved by the object having the features of the main claim. A method for producing such an object and a method for securely marking an object are the subject matter of the independent claims. Developments of the invention are the subject matter of the subclaims.

According to the invention, the object and the information to be secured have disposed therebetween an additional layer whose adhesive power to the cover sticker is greater at least in partial areas than the adhesive power of the additional layer to the object. This measure considerably increases security from tampering since the information to be secured remains invisible or is rendered unreadable upon removal of the cover sticker due to the different adhesion of the additional layer to the object and to the cover sticker. The inventive solution furthermore permits very economical securing of objects since the additional layer can be executed strictly by printing technology so that it is possible to use equipment already used in production of the card body. No additional technical devices or apparatus or elaborate additional steps are required.

The invention is thus based on the idea of increasing security not, or not only, by working to improve the structure of the cover sticker, but by impeding a seal break of a glued cover, or making tampering clearly visible once it is done, through an additional layer between the object and the information to be secured.

The information to be secured is preferably printed on the additional layer by an ink jet process and is in particular applied to the additional layer in black.

According to a preferred embodiment of the invention, the additional layer is formed by an ink layer of any color, preferably a white ink layer. Due to the stronger adhesion of the additional ink layer to the cover sticker at least in some areas, a part or even the whole ink layer adheres thereto upon removal of the cover sticker. The information to be secured is then enclosed invisibly or unreadably between the ink layer and the cover sticker and inaccessible to unauthorized reading.

If the cover sticker is glued back to the object after removal, the information to be secured can possibly be rendered visible and readable by scratching off the sticker. The object can then be used properly despite the attempt at tampering. Since the seal break did not make any relevant information accessible to the unauthorized person, the continuing usability does not result in any damage.

Upon partial detachment of the additional layer with the cover sticker, however, it is not possible to glue it on the information fractions remaining on the object exactly and in register. The attempt at tampering then becomes visible upon scratching and a complaint can be made or it can be made known depending on the circumstances. The case can also arise that in the attempt at tampering the detached cover sticker is glued on offset or twisted to such an extent that the information to be secured is illegible after scratching. The illegible information is then evidence of the seal break and the fact that the owner was unable to become aware of the information, so that a complaint can be made or the object exchanged without problems.

According to another preferred embodiment of the invention, the additional layer is formed by a multi-ply layer which comprises at least one ink layer and at least one further ink layer or lacquer layer disposed between the object and the ink layer. The lacquer layer can be formed in particular by a UV lacquer. This division makes it possible to design the ink layer for optimal opaqueness in order to prevent the information part located on the detached cover sticker from being readable. The adhesion properties of the additional layer on the object can be adjusted independently thereof with the help of the additional ink layer or the lacquer layer. Altogether this results in very flexible design options for the additional layer.

In both of the stated embodiments the ink layer located under the information to be secured can be formed by a monochrome ink layer. The color of said ink layer can be coordinated with the color of the information to be secured in order to produce high contrast between the information to be secured and the ink layer located thereunder, and thus good readability after scratching off the cover sticker. At the same time, the ink layer should cover well so that the information to be secured is not visible or readable with the sticker detached.

According to a preferred development of the latter embodiment, the multi-ply layer additionally comprises a second ink layer disposed between the lacquer layer and the first ink layer located under the information to be secured. Said second ink layer can have an irregular pattern or can contain blind information whose character corresponds to the information to be secured.

In this design the first ink layer serves essentially to promote the readability of the information after scratching off the cover sticker. The second ink layer, in contrast, only becomes visible upon unauthorized removal of the cover sticker and serves to better obliterate the information to be secured. For example, the second ink layer can contain an irregular striped or wavy pattern. Also, blind information, for example an invalid numeric string, can mislead the tamperer about the success of the seal break. Obviously, the type of pattern or the character of the blind information is advantageously coordinated with the character and type of information to be secured.

According to a preferred embodiment of the invention, the adhesive power of the additional layer to the cover sticker is greater than the adhesive power of the additional layer to the object. Upon detachment of the cover sticker, essentially the total additional layer then comes off and encloses the information to be secured invisibly between itself and the cover sticker.

Alternatively, it can be provided that the adhesive power of the additional layer to the cover sticker is greater than the adhesive power of the additional layer to the object in first areas, and the adhesive power of the additional layer to the cover sticker is smaller than the adhesive power of the additional layer to the object in second areas. Upon detachment of the cover sticker the information portion located in the first areas then remains on the sticker while the information portion located in the second areas remains on the object. Due to the separation of the two areas the information to be secured can no longer be deciphered after detachment.

The size and shape of the first and second areas are expediently coordinated with the information to be secured such that the latter is no longer decipherable after removal of the cover sticker. The first and second areas advantageously form a fine-scale structure, so that the information to be secured is divided into a multiplicity of small areas by detachment of the cover sticker. For example, the structure size can be coordinated with the line width of the letters in the case of numeric or text sequences, so that no large contiguous parts of a number or letter remain recognizable. It is likewise preferred in this connection that the first and second areas form an irregular structure. This further reduces the readability of the information parts remaining on the object.

The additional layer, according to an advantageous embodiment, has means for locally different adjustment of adhesive power. Said means can comprise a non-stick lacquer and/or an adhesion promoter applied locally between the information to be secured and the object. The means for locally different adjustment of adhesive power are preferably applied to the object by printing.

To obtain particularly economical securing of the object, the additional layer is printed on the object, optionally with all its sublayers. The additional layer is preferably printed by the offset process.

If the additional layer comprises ink layers, the inks used are preferably offset inks, in particular UV-drying offset inks. The main constituents of the offset inks are normally pigments as colorants, prepolymerized plastics such as acrylic resins as binders and photoinitiators.

The information to be secured can be in particular a character string such as a secret number or PIN number. The object can be for example a value document, in particular bank card, credit card, prepaid stored-value card such as a phonecard, or lottery ticket.

The cover sticker used can be any adhesive label known from the prior art. In particular, the cover sticker can be a scratch label which normally consists at least of a transparent carrier and a scratch-off cover layer.

For producing an object with information to be secured, such as a coding, identification, PIN number or the like, an object to be provided with the information is supplied, an additional layer with a first, uniform or locally different adhesive power to the object applied to the object, the information to be secured applied to the additional layer, and the information to be secured covered with a security cover sticker having a second adhesive power to the additional layer, the second adhesive power being greater at least in partial areas than the first adhesive power of the additional layer to the object.

As described above, an ink layer can be applied as an additional layer. Alternatively, a lacquer layer which adjusts the first adhesive power to the object can first be applied to the object, and then an ink layer be applied to the lacquer layer.

It can also be provided to apply a further ink layer with another color and/or another pattern to the ink layer present. Upon application of the additional layer, means for locally different adjustment of adhesive power can advantageously also be applied to the object, in particular a non-stick lacquer and/or an adhesion promoter can be applied locally to the object.

The layers of the additional layer are expediently printed, preferably by the offset process. Also, the information to be secured is advantageously printed on the additional layer by an ink jet process.

The invention further comprises a method for securely marking an object by which an additional layer with a first, uniform or locally different adhesive power to the object is applied to the object, a marking is applied to the additional layer, and the marking is covered with a security cover sticker which has a second adhesive power to the additional layer, the second adhesive power being greater at least in partial areas than the first adhesive power of the additional layer to the object. The production of the additional layer and the providing of the marking can be effected analogously to the above-described production of an object with information to be secured.

Further embodiments as well as advantages of the invention will be explained hereinafter with reference to the figures. The proportions shown in the figures do not necessarily correspond to the relations existing in reality and serve primarily to improve clearness.

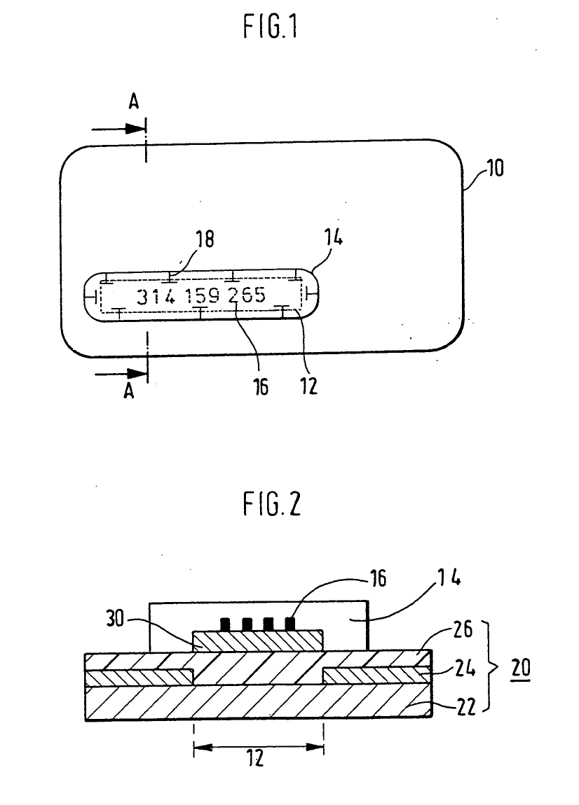

FIG. 1 shows a schematic representation of a stored-value card with a glued-on scratch label according to an embodiment of the invention, and

FIGS. 2 to 5 show schematic representations of stored-value cards according to different embodiments of the invention, each in cross section.

The invention will be explained in more detail by the example of a prepaid phonecard. FIG. 1 shows a schematic representation of a phonecard 10 with a numeric field 12 and a scratch label 14 glued over the numeric field 12. Printed on the numeric field 12 is a numeric string 16 which is invisible to the viewer when the scratch label 14 is glued on and intact, and is therefore shown by dash lines in the representation of FIG. 1. Outside the numeric field 12 the phonecard 10 can be provided with a design print not shown in FIG. 1, for example an advertising print, or with instructions for using the phonecard.

Scratch-off layers of the scratch label 14 can be removed by scratching with a sharp object or with the fingernail, thereby revealing the numeric string 16 located thereunder. To prevent the scratch label 14 from being simply removed and glued back on, the scratch label 14 is provided with a number of security slits 18 on which the scratch label 14 tears when being removed. An attempt at tampering by removing the scratch label 14 is thus considerably impeded.

Besides the security slits 18 of the label 14, the phonecard 10 has an additional layer provided under the printed numeric string 16 to increase security from unauthorized tampering, the structure of said additional layer being explained in more detail on the basis of some preferred embodiments with reference to FIGS. 2 to 5. FIGS. 2 to 5 show the phonecard 10 in cross section along the chain-dotted line A-A of FIG. 1 to illustrate the layer structure of the card.

According to the embodiment shown in FIG. 2, the phonecard 10 comprises a card body 20 with a card carrier 22 which can consist of paper, plastic or a multilayer substrate. The card carrier 20 has applied thereto by the offset process a design print 24 which has a gap forming the numeric field 12 in the area of the numeric string 16.

Depending on the character of the design print 24 and the additional layer described below, such a gap can also be omitted and the design print 24 be designed continuously. The design print layer 24 has printed thereon a transparent UV lacquer 26 as a protective layer. The UV lacquer layer 26 can likewise have a gap in the area of the numeric field 12 to ensure better adhesion of the subsequently printed layers to the base surface.

The UV lacquer layer 26 has printed thereon by the offset process, in the embodiment of FIG. 2, a white ink layer 30 whose extension can correspond to the size of the numeric field 12. The numeric string 16 is printed on the ink layer 30 by an ink jet process, and the numeric field 12 and the printed numeric string 16 are covered by the glued-on scratch label 14.

The adhesive power of the ink layer 30 to the scratch label 14 is greater at least in partial areas than the adhesive power of the ink layer 30 to the card body 20. Thus, upon an attempt to detach the scratch label 14 e.g. with a scalpel, at least part of the ink layer 30 remains on the label 14 and is detached therewith. At most a fraction of the numeric string 16, which can no longer be deciphered, then remains on the numeric field 12. At the same time the white ink layer 30 adhering to the scratch label 14 prevents the part of the numeric string 16 enclosed between the ink layer 30 and the label 14 from being read. The balance of value stored on the phonecard 10 can thus not be retrieved by the tampering.

If the scratch label 14 is glued back on the card body 20 after detachment, this can be done both true to side and laterally reversed. When the label 14 is subsequently scratched there are two possibilities:

(1) The numeric string 16 is still readable. This can be the case if the label 14 is glued back on true to side and with little offset, or if upon detachment the total ink layer 30 adheres to the label 14. The balance of value of the phonecard 10 can then still be used. However, upon separation of the numeric string 16 into two parts it is not possible to glue the label on the information fractions remaining on the card body 20 exactly and in register, so that the tampering becomes visible after scratching and a complaint can optionally be made.

(2) The numeric string 16 is no longer readable. This can be the case if the label 14 is glued on laterally reversed or with great offset. The illegible information is evidence firstly of the tampering and secondly of the fact that the owner was unable to spend the balance of value. It is therefore possible to make a complaint or exchange the phonecard.

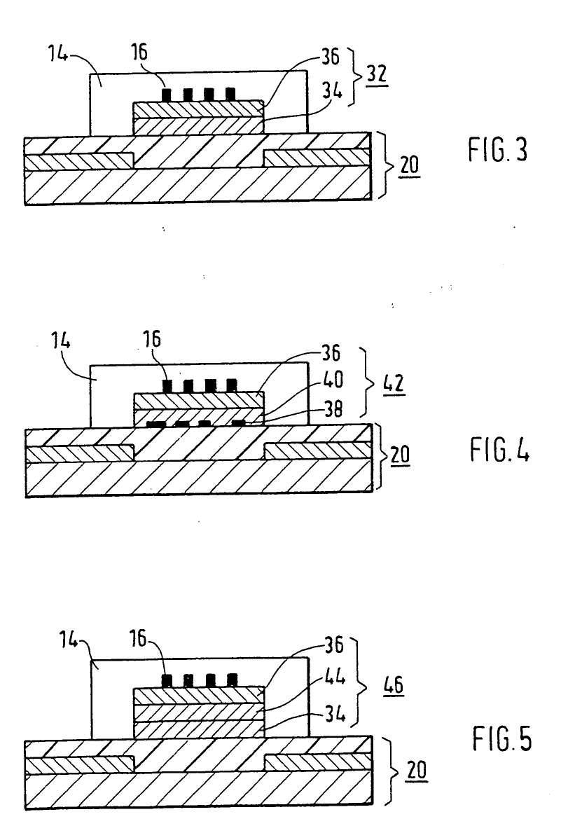

The embodiment of FIG. 3 differs from the embodiment of. FIG. 2 only in the design of the additional layer, while the card body 20, the numeric string 16 and the scratch label 14 are formed as described above. According to FIG. 3 the numeric string 16 and the card body 20 have disposed therebetween an additional layer 32 which consists of a lacquer layer 34, for example a UV lacquer layer, printed on the card body 20 and an ink layer 36 printed on the lacquer layer.

The lacquer layer 34 permits the adhesive power of the additional layer 32 to be adjusted exactly to the card body 20, so that the adhesive power of the additional layer 32 to the scratch label 14 is greater at least in partial areas than the adhesive power of the additional layer 32 to the card body 20. The ink layer 36 on the one hand serves as a base surface for the numeric string 16 and on the other hand prevents the part of the numeric string 16 detached together with the scratch label 14 from being read. The two-layered structure of the additional layer 32 permits precise adjustment of the adhesion properties between additional layer 32 and card body 20 while simultaneously optimizing the ink layer 36 for picture contrast and opaqueness.

In the embodiment of FIG. 4 a non-stick lacquer 38 is applied to the card body 20 in places to reduce the adhesive power of the additional layer 42 specifically in said places. The non-stick lacquer 38 has printed thereover an adhesion promoter 40 which firmly connects the additional layer 42 with the card body 20 in the places not provided with non-stick lacquer 38. In the additional layer 42 two areas of different adhesive power to the card body 20 thus arise which are separated upon detachment of the label 14.

The first areas of the additional layer 42 over the places provided with non-stick lacquer 38 are removed upon detachment of the label 14 together with the part of the numeric string 16 disposed thereon. The second areas in the other places remain on the card body 20. The size and shape of the first and second areas are coordinated with the information to be secured, in the present case with numeric strings, in order to guarantee that the information parts remaining on the card body are no longer decipherable. For example, the non-stick lacquer can be printed on in the form of closely adjacent, irregularly formed curved sections.

A further embodiment of the invention is shown in FIG. 5. In this design the additional layer 46 has not only the first ink layer 36 located under the numeric string 16 and the lacquer layer 34 printed on the card body 20 for adjusting the adhesion properties but also a second ink layer 44 disposed between the first ink layer 36 and the lacquer layer 34. While the color of the first ink layer 36 is selected to obtain good readability of the numeric string 16, the second ink layer 44 contributes to making the part of the numeric string adhering to the label 14 after detachment remain unreadable. The second ink layer 44 has for this purpose an irregular wavy pattern of fine-scale structure in this embodiment. It can also be provided with blind information in the form of an invalid numeric string to deceive a tamperer about the success of his intervention. It is obvious that the two ink layers 44, 36 of FIG. 5 can also be combined with the nonstick lacquer/adhesion promoter structure of FIG. 4.

1. An assembly having information to be secured, such information exemplified by a coding, identification, PIN number or the like, comprising:
an object on which the information is to be secured, and
a security cover sticker having a base area smaller than the object and covering the information to be secured,
wherein,
an additional layer is disposed between the object and the information to be secured,
said additional layer comprising an ink layer or lacquer layer disposed directly on the object, and
the adhesive strength of the additional layer to the cover sticker is greater at least in partial areas than the adhesive strength of the additional layer to the object.

2. The assembly according to claim 1, wherein the information to be secured is printed on the additional layer by an ink jet process.

3. The assembly according to claim 1, wherein the information to be secured is applied to the additional layer in black.

4. The assembly according to claim 1, wherein the additional layer is formed by an ink layer.

5. The assembly according to claim 1, wherein the additional layer is formed by a multi-ply layer and comprises at least one upper ink layer and at least one lacquer layer disposed between the object and the upper ink layer as the ink layer or lacquer layer.

6. The assembly according to claim 5, wherein the lacquer layer is formed by a UV lacquer (34).

7. The assembly according to claim 4, wherein the ink layer located under the information to be secured is formed by a monochrome ink layer.

8. The assembly according to claim 4, wherein the color of the ink layer located under the information to be secured is coordinated with the color of the information to be secured to produce high contrast between the information to be secured and the ink layer located thereunder.

9. The assembly according to claim 5, wherein the multi-ply layer comprises a second ink layer disposed between the lacquer layer and the upper ink layer located under the information to be secured.

10. The assembly according to claim 9, wherein the second ink layer has an irregular pattern.

11. The assembly according to claim 9, wherein the second ink layer contains blind information whose character corresponds to the information to be secured.

12. The assembly according to claim 1, wherein the adhesive strength of the additional layer to the cover sticker is greater than the adhesive strength of the additional layer to the object .

13. The assembly according to claim 1, wherein the adhesive strength of the additional layer to the cover sticker is greater than the adhesive strength of the additional layer to the object in first areas, and the adhesive strength of the additional layer to the cover sticker is smaller than the adhesive strength of the additional layer to the object in second areas.

14. The assembly according to claim 13, wherein the first and second areas form a fine-scale structure.

15. The assembly according to claim 13, wherein the first and second areas form an irregular structure.

16. The assembly according to claim 13, wherein the size and shape of the first and second areas are coordinated with the information to be secured such that it the information is no longer decipherable after removal of the cover sticker.

17. The assembly according to claim 13, wherein the additional layer has means for effecting locally different adjustment of adhesive strength.

18. The assembly according to claim 17, wherein the means for effecting locally different adjustment of adhesive strength comprises a non-stick lacquer applied to the object locally between the information to be secured and the object.

19. The assembly according to claim 17, wherein the means for effecting locally different adjustment of adhesive strength comprises an adhesion promoter applied to the object locally between the information to be secured and the object.

20. The assembly according to claim 17, wherein the means for effecting locally different adjustment of adhesive strength is applied to the object by printing.

21. The assembly according to claim 1, wherein the additional layer is printed on the object.

22. The assembly according to claim 21, wherein the additional layer is printed on the object by an offset process.

23. The assembly according to claim 1, wherein the information to be secured is a character string, exemplified by a secret number or PIN number.

24. The assembly according to claim 1, wherein the assembly is a value document, exemplified by a bank card, credit card, prepaid stored-value card such as a phonecard, or lottery ticket.

25. The assembly according to claim 1, wherein the cover sticker is an adhesive label.

26. The assembly according to claim 1, wherein the additional layer is formed on the object in a size of an information field comprising the information to be secured.

27. The assembly according to claim 1, wherein the cover sticker has a larger base area than the additional layer.

28. A method for producing an assembly with information to be secured, exemplified by a coding identification, PIN number or the like, comprising the steps:
a) supplying an object to be provided with the information,
b) applying an additional layer to the object with a first, uniform or locally different adhesive strength to the object, the additional layer comprising an ink layer or lacquer layer disposed directly on the object,
c) applying the information to be secured to the additional layer, and
d) covering the information to be secured with a security cover sticker having a smaller base area than the object and a second adhesive strength to the additional layer, the second adhesive strength being greater at least in partial areas than the first adhesive strength of the additional layer to the object.

29. The method according to claim 28, including applying an ink layer as the additional layer in step b).

30. The method according to claim 28, wherein:
a lacquer layer which adjusts the adhesive strength of the additional layer to the object is applied to the object as the ink layer or lacquer layer, and
an ink layer is applied to the lacquer layer.

31. The method according to claim 30, including:
applying a further ink layer with another color and/or another pattern is to the ink layer present.

32. The method according to claim 28, wherein in step b) means for locally different adjustment of adhesive strength are applied to the object, in particular a non-stick lacquer and/or an adhesion promoter is applied locally to the object.

33. The method according to claim 28, wherein the layers applied in step b) are printed on, preferably printed by an offset process.

34. The method according to claim 28, wherein the information to be secured is printed on the additional layer by an ink jet process in step c).

35. The method according to claim 28, wherein the additional layer is applied to the object in the size of an information field comprising the information to be secured.

36. The A method according to claim 28, wherein the cover sticker is selected so as to have a greater base area than the additional layer.
